(19) United States
(12) Patent Application Publication
(10) Pub. No.: US 2012/0297087 A1
(43) Pub. Date: Nov. 22, 2012

(54) Method And Apparatus For Message Distribution In A Device Management System

(75) Inventors: Filip Humble, Mol (BE); Vinod T. Nair, Austin, TX (US); Arabinda Bose, Cedar Park, TX (US); Bahadir Danisik, Antwerpen (BE)

(73) Assignee: Alcatel-Lucent USA Inc., Murray Hill, NJ (US)

(21) Appl. No.: 13/110,374

(22) Filed: May 18, 2011

(51) Int. Cl. G06F 15/173

(52) U.S. Cl. 709/238

(57) ABSTRACT

A method and apparatus for managing CPE devices. In managing a CPE, an ACS must first establish a communication session with the CPE. In accordance with the present invention, the connection request formed by the ACS and containing proxy information is transmitted to a primary blast box. The primary blast box, which includes a blast box registry, forwards the connection request to a plurality of secondary blast boxes, each secondary blast box being associated with a respective CGN private network of the communications network. The secondary blast boxes in turn removes the proxy information and forwards the connection request to one or more CPEs in the private network encompassed by the corresponding CGN. Authentication information sent with the proxy information uniquely permits authentication of the connection request in the target CPE. When authentication occurs, the CPE initiates a communication session with the ACS so that the desired management function may be executed.

### TECHNICAL FIELD

The present invention relates generally to the field of communications networks, and, more particularly, to a method and apparatus for initiating contact with a CPE device through a communications network in which a CGN boundary may be implemented.

### BACKGROUND

The following abbreviations are herewith defined, at least some of which are referred to within the following description of the state-of-the-art and the present invention.

### ACS Auto-Configuration Server

### CGN Carrier Grade NAT

### CPE Customer Premises Equipment

### IP Internet Protocol

### NAT Network Address Translation

TR Technical Report (a Broadband Forum term)

Communications networks have come into common use and, at least in many areas, are widely available. Many subscribers take advantage by forming networks of electronic devices in their home or office and connecting the home network to the larger communications network. Through the communications network, the subscribers may access the Internet and other subscribers as well as application servers that provide a great many different services. The communications network typically includes an access network portion that allows each subscriber to reach the larger communications network and all of the applications available through it. The access network portion may be considered as extending to a demarcation point at the subscriber's premises, where it connects directly or indirectly to a device referred to as a CPE (consumer premises equipment) device. An example of a CPE is a router or residential gateway device that in turn connects to the various components of a home network.

Since CPE is located in a home or small business, or some other similar location, as a group they are geographically widely dispersed and are typically located inside of a house or other building to which the carrier operating the communications network does not have unlimited access. For this reason it is desirable to be able to remotely perform management functions, such as upgrading applications or device firmware resident on the device, or confirming the device's configuration or status. Because of the large number of CPE devices being served by the network, it is also an advantage if this is done at least somewhat automatically.

A device that is capable of remotely managing CPE devices associated with a communications network may be generically referred to as an ACS (auto-configuration server). CPE devices joining the network register with the ACS and often periodically send to it messages indicating their status. When the ACS needs to contact a CPE to perform some management function, it uses an address supplied by the CPE at registration (or at a later time) to do so. One standard protocol dealing with the communication between an ACS and a CPE is Broadband Forum's TR-69 protocol.

Unfortunately, many communications networks reply on the IPV4 version of the Internet Protocol; with the proliferation of devices seeking IP addresses, even with the vast number of IPV4 address initially available they will eventually be exhausted and are in some networks already in short-supply. To alleviate this problem the concept of a CGN (carrier grade NAT (network address translation)) boundary has been introduced. A plurality of CGNs are typically implemented in a communications network, creating, in effect, a number of private networks, each private network encompassing a number of CPEs. Each CPE associated with a private network is assigned a private IP address. Since each private network incorporates only a certain number of CPEs, and, of course, the same private IP addresses may be re-used in a different private network, the number of private IP addresses is more than adequate. When a CPE wishes to communicate with a remote device, a public IP address may be temporarily assigned for the communication session. In this environment this public address is typically assigned by the CGN for a communication session involving a CPE in a private network associated with the CGN. When the session terminates, the assigned public IP address may be reassigned to another CPE.

This may cause complications in the management of a CPE device because the public IP address it provides the ACS upon registration may not be (permanently) uniquely assigned to the CPE. The ACS cannot simply address a message to the CPE using the private address that is uniquely recognized only within the private network. In such cases there are few options beyond simply waiting for the CPE to send a periodic status update or some other kind of message, when the ACS may be able to use the public IP address that has been temporarily assigned. This may be less than satisfactory as the management function might be best initiated immediately. For example, if a firmware update is necessary in response to a security threat it should be installed immediately. In some cases, however, it may be some time—even several weeks—before the CPE (not knowing of the threat, of course) initiates a communication session where the management function could be performed.

If all of the CPEs in a communication network include a STUN client according to the TR-111 protocol, a STUN server may be able reach those so equipped. But presently only a small percentage of CPE clients include the STUN client, and the cost of altering that percentage in a meaningful way may be prohibitive. Moreover, the STUN protocol may not scale well and would therefore be ill-suited to serve the large number of CPEs associated with many modern communications networks. Clearly, another solution would be of great advantage.

Accordingly, there has been and still is a need to address the aforementioned shortcomings and other shortcomings associated with remotely managing CPE devices. These needs and other needs are satisfied by the present invention.

Note that the techniques or schemes described herein as existing or possible are presented as background for the present invention, but no admission is made thereby that these techniques and schemes were heretofore commercialized or known to others besides the inventors.

### SUMMARY

The present invention is directed at a manner of managing CPE (customer premises equipment) devices, particularly in a carrier network environment where one or more CGN (carrier grade network address translation) boundaries have been installed. In one aspect, the present invention is a method of initiating communications with a CPE device including receiving in a primary blast box a connection request directed to the CPE, the connection request comprising proxy information that includes an IP address associated with the CPE, and forwarding the connection request to at least one secondary blast box, wherein the at least one secondary blast box is associated with a private network of the communication network. Each private network may be serviced by one or more CGNs. The method may further include extracting the proxy information from the connection request and forwarding the connection request without the proxy information to the IP address associated with the CPE.

In another aspect, the present invention is a network element such as a blast box for facilitating communications with a CPE that includes a processor, a memory device in communication with the processor, the memory device comprising a secondary element registry, and a message handler controlled by the processor configured to receive connection request messages and to forward the connection request messages received in the network element to secondary network elements listed in the secondary element registry.

In yet another aspect, the present invention is a system for managing CPE devices that includes a primary blast box having a blast box registry and at one or more secondary blast boxes that have a CPE registry. In this aspect the primary blast box is configured to receive a connection request from an ACS and to forward the connection request to at least one secondary blast box.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a typical communications network;

FIG. 2 is a simplified schematic diagram illustrating the communications network of FIG. 1 with a plurality of CGNs in place;

FIG. 3 is a simplified schematic illustrating a blast box system according to an embodiment of the present invention;

FIG. 4 is a simplified schematic diagram illustrating selected components of a communications network according to an embodiment of the present invention;

FIG. 5 is a simplified block diagram illustrating selected components of a primary blast box according to an embodiment of the present invention;

FIG. 6 is a simplified block diagram illustrating secondary blast box according to an embodiment of the present invention;

FIG. 7 is a flow diagram illustrating a method according to an embodiment of the present invention;

FIG. 8 is a flow diagram illustrating a method according to an embodiment of the present invention; and

FIG. 9 is a simplified schematic diagram illustrating selected components of a communications network according to an embodiment of the present invention.

### DETAILED DESCRIPTION

The present invention is directed at a manner of managing CPE (customer premises equipment) devices, particularly in a carrier network environment where one or more CGN (carrier grade network address translation) boundaries have been installed. As mentioned above, the CGN may have been installed to alleviate IP address depletion. While successful in this regard, the CGNs pose challenges for CPE management that heretofore have not been satisfactorily addressed.

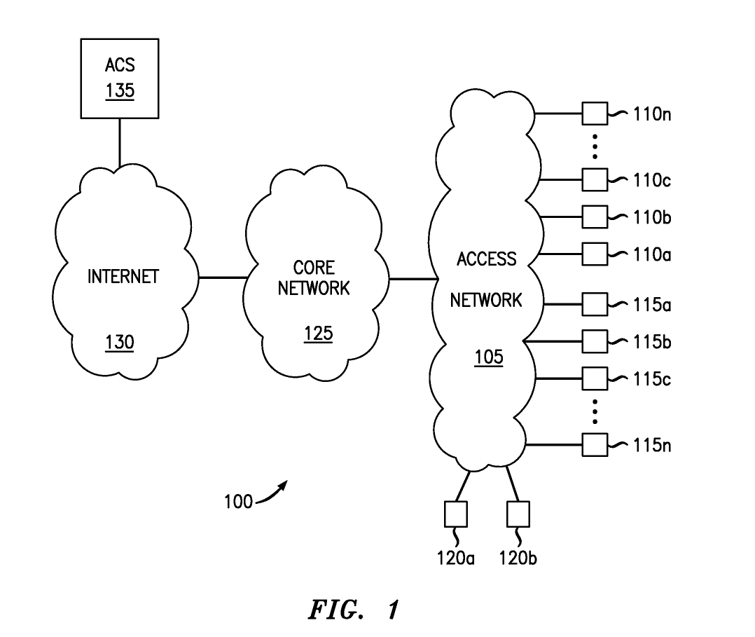

FIG. 1 is a simplified schematic diagram illustrating selected components of a typical communications network 100. As shown in FIG. 1, communication network 100 includes an access network 105, which provides a connection to one or more, and usually to a large number of CPE devices (sometimes simply referred to as CPEs). Illustrated in FIG. 1 are CPE devices 110a through 110n, 115a through 115n, and 120a through 120b, representing the CPE devices served by the access network 105. Of course, as this implies the number of CPE devices served by an access network may vary over time, and those with a physical connection to an access network may for a time be inactive.

Each of the CPEs represented in FIG. 1 may be associated with a subscriber residence, although there may be more than one such device in any given home. CPE devices may also be found in home offices and some small businesses. The specific use, type, or location of the CPEs provided network access by access network 105 is not relevant to the present invention unless specified in a particular embodiment.

In the exemplary communications network of FIG. 1, the access network 105 is in communication with a core network 125, typically operated by a carrier that carries and routes the data traffic to and from the subscribing CPEs and provides a connection to other networks and devices as well. Here, core network 125 is in communication with the Internet 130. Note that each of the access network 105, the core network 125, and Internet 130, represented by respective clouds in FIG. 1, are in reality made up of a number of switching and routing components and connect to each other via gateways, which for simplicity are not separately shown in FIG. 1.

In the exemplary network of FIG. 1, an ACS 135 is also present. ACS 135 is used to configure CPEs at startup, keep track of their status, and provide remote maintenance and repair functions for each CPE device. As should be apparent, in the usually case the ACS 135 is put into place and new CPEs may be added to the network from time to time by registering with the ACS. In some cases, a physical connection such as a wire or fiber optic cable may have to be installed from the access network to the subscriber's residence to enable registration.

Note that while in this example the ACS communicates with the CPE devices via the Internet and the core and access networks in other implementations the configuration may be different. In any case, during registration the CPE provides the ACS with its assigned IP address so that the ACS can contact the CPE at a later time to, for example, perform upgrades or confirm its operational status.

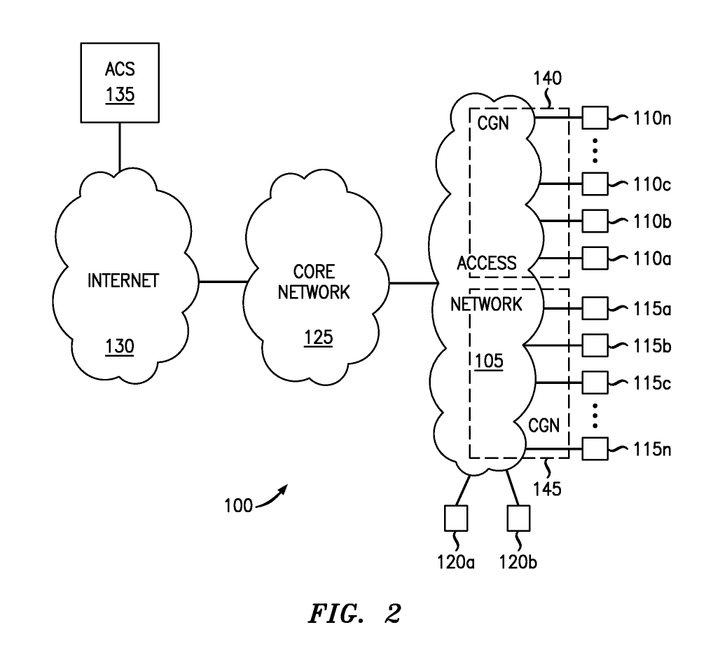

As mentioned above, however, many networks rely on the IPV4—version of the Internet Protocol, and with the proliferation of devices seeking IP addresses some compromise had to be found. Even with the vast number of IPV4 address initially available, they will eventually be exhausted and are in some networks already in short supply. To alleviate this problem the concept of a CGN has been introduced. FIG. 2 is a simplified schematic diagram illustrating communications network 100 with a plurality of CGNs in place. Each CGN serves all or a portion of a private network (not separately referred to in FIG. 2) that can assign private IP addresses to each CPE device. Since each private network incorporates only a certain number of CPEs, the number of private IP addresses is more than adequate. When a CPE wishes to communicate with a remote device, a public IP address may be temporarily assigned for the communication session. When the session terminates in some way, the assigned public IP address may be reassigned to another CPE.

In the exemplary network of FIG. 2, for clarity only two CGNs are illustrated, though in a typical communications network there may be many more. In FIG. 2, the access network 105 of communications network 100 includes CGN 140 and CGN 145. In this example, CGN 140 establishes a private network that encompasses CPE devices 110a through 110n, and CGN 145 similarly encompasses 115a through 115n. Note however, that while for convenience only one CGN is depicted for each private network; in reality each private network may use many CGNs.

In the communications network 100 of FIG. 2, CPE 120a and CPE 120b are not served by a CGN and do not form part of a private network, but they do remain accessible via access network 105. In fact, CPEs 120a and 120b are assigned and accessible using public IP addresses, but cannot be accessed, for example, simply by addressing a proxy server dedicated to either CGN 140 or CGN 145. A manner of reaching any of the CPE devices associated with communications network 100 according to the present invention will now be described.

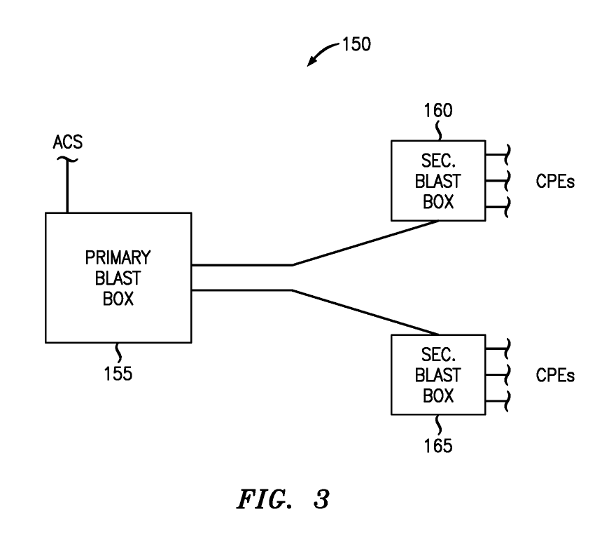

FIG. 3 is a simplified schematic illustrating a blast box system 150 according to an embodiment of the present invention. In this embodiment, blast box system 150 includes a primary blast box 155 and two secondary blast boxes, referred to in FIG. 3 as secondary blast box 160 and secondary blast box 165. The secondary blast boxes are proxy devices that may be respectively associated with a private network, for example one of the two associated with CGNs 140 and 145 illustrated in FIG. 2. Note that in many implementations, there may be many more secondary blast boxes, especially where a larger number of CGNs servicing multiple private networks have been implemented.

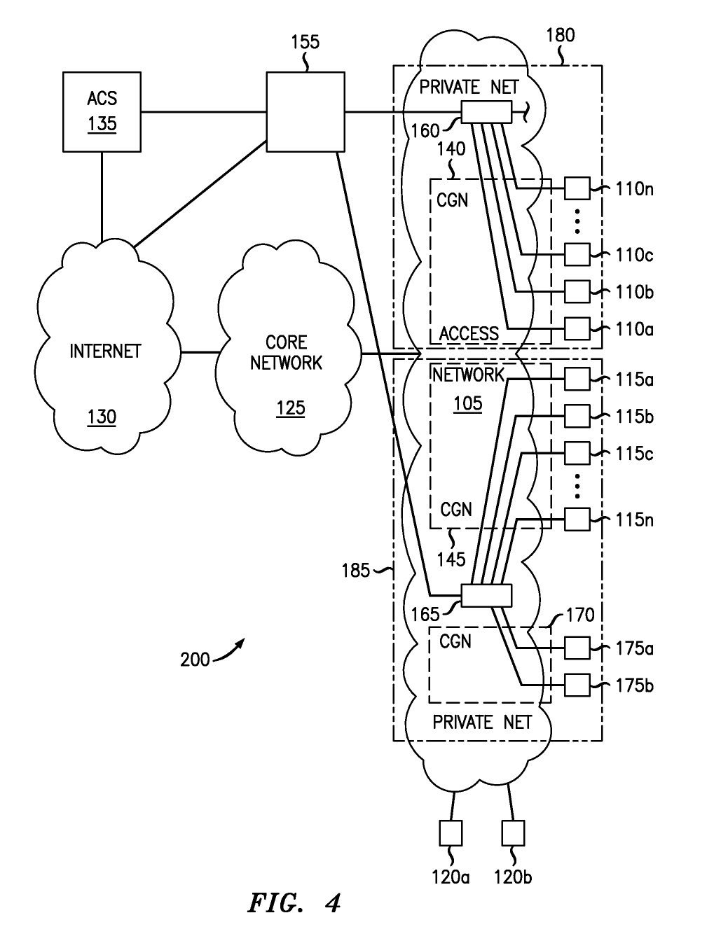

In this embodiment, a shown in FIG. 3 the primary blast box 155 is in communication with an ACS (not shown) and each of the secondary blast boxes 160 and 165. The secondary blast boxes are in turn in communication with one or more CPE devices (also not shown). In a preferred embodiment, the CPEs associated with each secondary blast box coincide with the CPEs served by a particular private network, as is illustrated in FIG. 4. Note, however, that CGNs may in some networks overlap, and any particular CPE may be addressable by more than one secondary blast box.

FIG. 4 is a simplified schematic diagram illustrating selected components of a communications network 200 according to an embodiment of the present invention. As should be apparent, network 200 is representative of the addition of blast box system 150 to the exemplary network 100 of FIG. 2. For purposes of illustration, private networks 180 and 185 are also shown. Private network 180 is associated with CGN 140, though again, there could be more than one CGN, and in some cases many, associated with a given private network. Private network 185 is shown, for example, as associated with CGN 145 and CGN 170. CGN 170 serves CPEs 175a and 175b.

In the embodiment of FIG. 4, secondary blast box 160 is associated with the private network 180, and secondary blast box 165 is associated with the private network 185. Note that in this embodiment, ACS 135 may communicate with primary blast box 155 directly or via the Internet 130, to which they are both connected. In this embodiment a direct connection is shown between the primary blast box 155 and the secondary blast boxes 160 and 165, which need to be reachable by primary blast box 155. In other embodiments, however, one or more intermediate components may be present but this reachability should not be compromised. Operation of the blast box system 150 in the network 200 will now be described in more detail, beginning with each of its component parts.

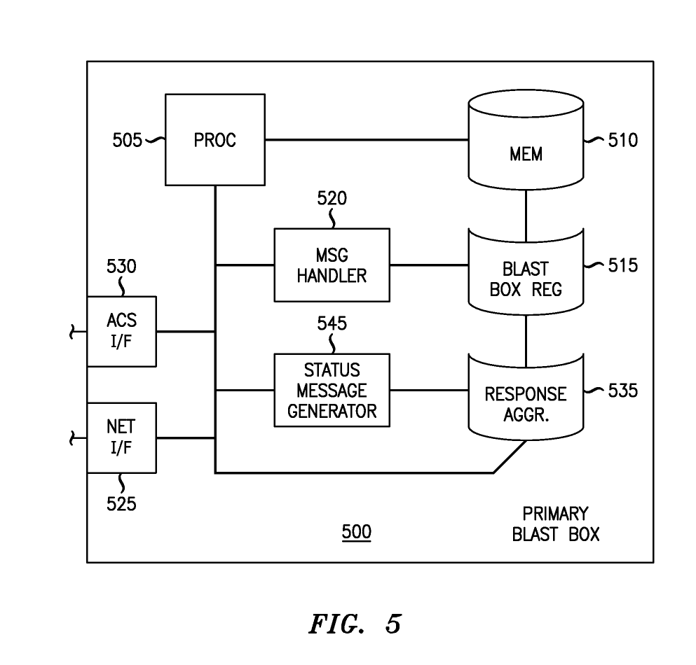

FIG. 5 is a simplified block diagram illustrating selected components of a primary blast box 500 according to an embodiment of the present invention. In accordance with the present invention, the primary blast box is typically implemented as a physical processor executing instructions stored as software in a non-transitory medium. In other embodiments, it may be implemented as a combination of executable software and hardware such as an ASIC. The primary blast box may be a standalone device or incorporated in a multifunction apparatus that performs other duties as well. In some implementations it may, for example, be implemented in an ACS such as ACS 135 illustrated in FIG. 4. In another alternate embodiment, the primary blast box may for redundancy or scalability be implemented in a number of separate components front-ended, for example, by a load balancer.

Returning to the embodiment of FIG. 5, blast box 500 includes a physical memory device 510 for storing data and program instructions executable by processor 505 in accordance with the present invention. Shown separately is a blast box registry 515, which maintains the list and addresses of each other blast box in the blast box system (see, for example, blast box system 150 of FIG. 3). Blast box registry 515 is dynamically updateable to reflect the creation or removal of CGN private networks. The registry 515 includes the addresses by which each of the listed blast boxes is addressable. Connection-request response aggregator 540 aggregates the responses, if any, received from secondary blast boxes (or other entities) to which the connection requests have been forwarded. Message handler 520 processes and forwards connection requests received from the ACS or similar elements to blast boxes listed in the registry. Connection request status message generator 545 generates a status message for transmission to the ACS indicating whether the connection request was successfully authenticate with the target CPE. Although it is possible that some of the blast boxes listed in the registry may be flagged as inactive and not included, in most cases it is preferable to simply remove from the registry blast boxes that are for some reason (for example, an outage) not to be addressed.

In the embodiment of FIG. 5, a network interface 525 is present for communicating with one or more communications networks, as is an ACS interface 530 for directly communicating with an ACS. More or fewer interfaces may be present depending on the needs of a particular implementation, and in some implementations a single interface may be used for interfacing with multiple entities. Note that the embodiment of FIG. 5 is exemplary and not limiting; other configurations are possible without departing from the present invention as recited in a particular embodiment.

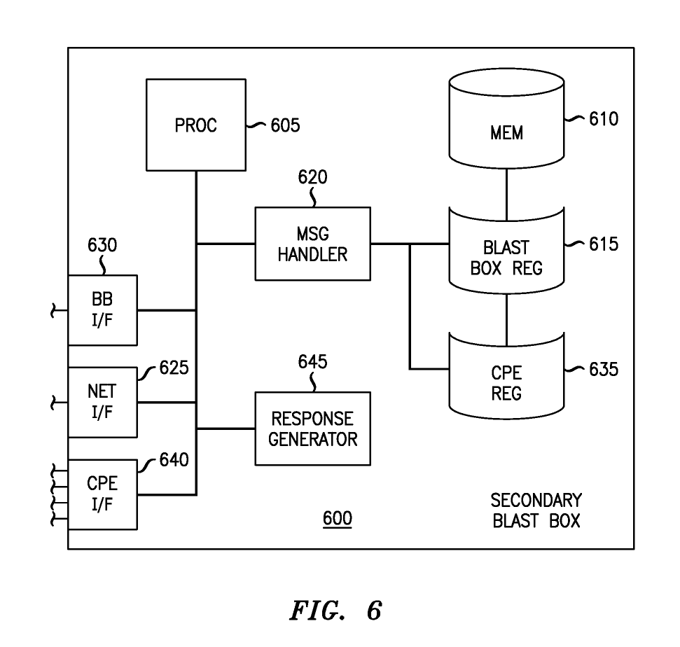

FIG. 6 is a simplified block diagram illustrating secondary blast box 600 according to an embodiment of the present invention. In accordance with the present invention, each secondary blast box is typically implemented as a physical processor executing instructions stored as software in a non-transitory medium. In other embodiments, it may be implemented as a combination of executable software and hardware such as an ASIC. The secondary blast box may be a standalone device or incorporated in a multifunction apparatus that performs other duties as well. In a communications network including multiple secondary blast boxes, there is no requirement that they be identically configured. One or more of them may also be incorporated in the same physical component. In another alternate embodiment, a secondary blast box may be implemented in a number of separate components front-ended, for example, by a load balancer.

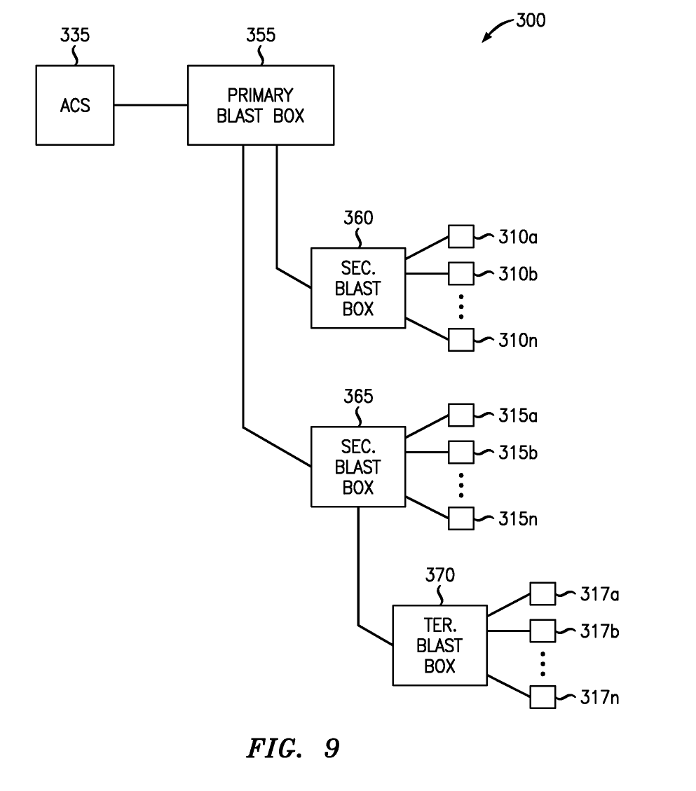

In the embodiment of FIG. 6, blast box 600 includes a physical memory device 610 for storing data and program instructions executable by processor 605 in accordance with the present invention. Shown separately is a blast box registry 615, which in a secondary blast box is normally left empty. In some implementations, however, other blast boxes in the blast box system may be listed but designated as inactive. In a multi-tier blast box system (see, for example, communications network 300 of FIG. 9), however, the tertiary blast box or boxes to which received connection request messages should be addressed are listed in the blast box registry 615 and, if applicable, flagged as active. A CPE registry 635 is also present, and contains a list of CPEs in the CGN private network or networks with which the secondary blast box is associated. CPE registry is dynamically updated to reflect new CPEs that have been added or removed from the private network associated with blast box 600. In some embodiments the blast box 600 may periodically communicate with each CPE to confirm its status; in others the CPE registry 635 is only updated when a status notification is received from another component.

In this embodiment, a message handler 620 processes and forwards connection requests received from the primary blast box to CPEs listed in the CPE registry and, if applicable, blast boxes in the blast box registry 615. A connection request status message generator 645 is present for generating a message to be transmitted to the primary (or other higher tier) blast box indicating whether the connection request was successfully authenticated. Note that although it is possible that some of the blast boxes listed in the registry may be flagged as inactive and not included, in most cases it is preferable to simply remove from the registry blast boxes that are for some reason (for example, an outage) not to be addressed.

In the embodiment of FIG. 6, a network interface 625 is present for communicating with one or more communications networks, if necessary, as is a blast box interface 630 for directly communicating with a primary or higher tier blast box. A CPE interface 640 permits communication with the CPE devices associated with secondary blast box 600. More or fewer interfaces may be present depending on the needs of a particular implementation, and in some implementations a single interface may be used for interfacing with multiple entities. Note that the embodiment of FIG. 6 is exemplary and not limiting; other configurations are possible without departing from the present invention as recited in a particular embodiment.

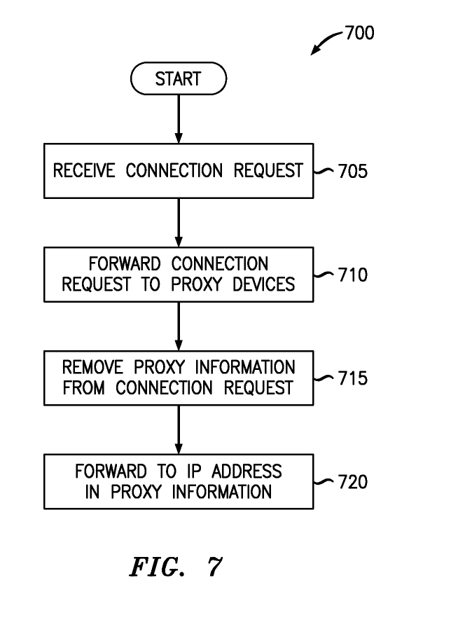

FIG. 7 is a flow diagram illustrating a method 700 according to another embodiment of the present invention. At START it is presumed that the components necessary to the performance of method 700 are available and operational according to the present invention. The process then begins with the receipt at a blast box of a connection request message directed to a CPE (step 705). In most implementations, the connection request is sent by the ACS or an analogous device for the purpose of, for example, checking the status of or providing maintenance or upgrades for the CPE to which the connection request is directed. As mentioned above, however, the ACS is not necessarily aware of a public IP address uniquely associated with the CPE it is trying to reach. It does, however, have an IP address that may be the private IP address of the CPE assigned by a CGN if one has been implemented. The ACS includes this private IP information in the proxy information that part of the connection request message. The connection request message may be, for example, an HTTP GET message sent in accordance with TR-69.

In accordance with this embodiment of the present invention, the connection request is then forwarded to one or more proxy devices (step 710), for example secondary blast boxes. Preferably, there will be at least one proxy device associated with each private network that has been implemented in the network. The proxy information is extracted from the connection request (step 715) and the connection request without the proxy information is forwarded to the IP address included in the proxy information (step 720). Note that even when the proxy information is extracted, it is understood that the authentication information will be retained and transmitted as necessary for authentication to occur with the target CPE.

In one embodiment (not shown), for example, this authentication information may include CR (connection request) credentials that were generated by the ACS and transmitted to the CPE when the CPE first registered (or perhaps at a later time, although this delay is not preferred). It may also include a CR URL generated by the CPE and provided to the ACS at registration or in a subsequent inform message. This CR URL may include, for example, the CPE serial number, manufacturer OUI, or product class information. Other forms of authentication information that uniquely identify the CPE may of course be used as well. And of course, the ACS may use or incorporate the information it receives from the CPE in any credentials it generates.

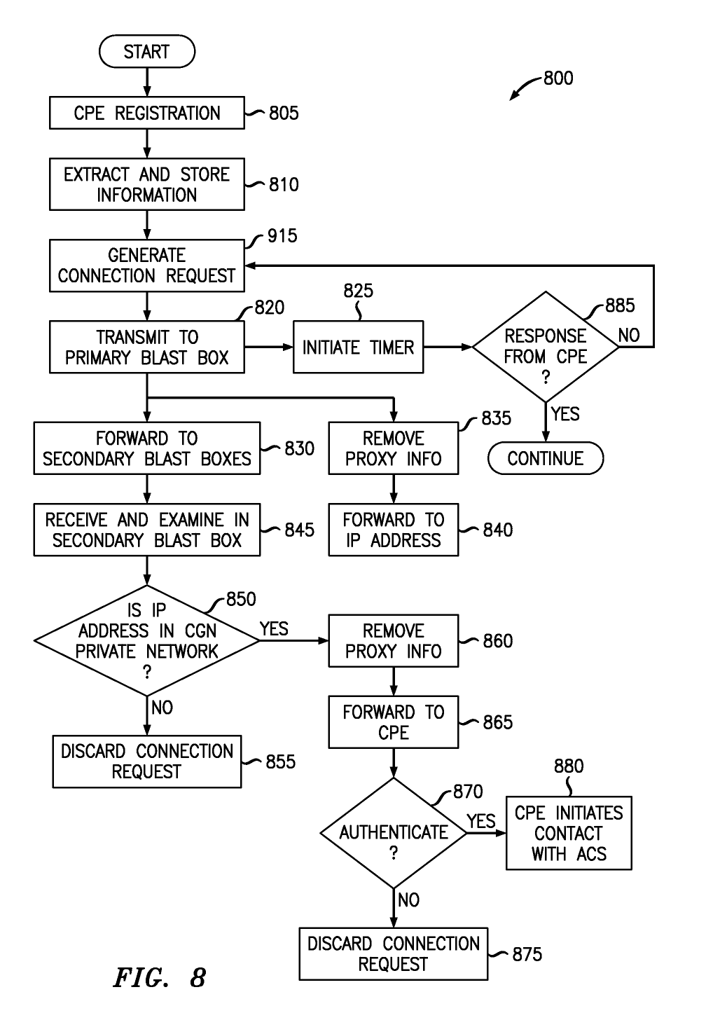

FIG. 8 is a flow diagram illustrating a method 800 according to an embodiment of the present invention. At START it is presumed that the components necessary to the performance of method 800 are available and operational according to the present invention. Note that some process steps of method 800 are in some ways analogous to operations of method 700, described above, but this does not imply that steps of one embodiment are necessarily incorporated from the other.

In the embodiment of FIG. 8 it is presumed that an ACS is in communication with and is being used to manage some or all of the CPE devices of a communications network. Although no particular network size or configuration is required, the invention is used to great advantage where a large number of CPEs are served by the network and one or more CGNs have been implemented, for example to conserve IP addresses.

In this embodiment, the process then begins when a CPE registers (step 805) with the ACS. The CPE (like most CPEs associated with the communications network) typically registers at least at startup and perhaps from time to time during its operation. The registration message (like later communications) will include an IP address for the CPE and authentication information that may be used in authenticating future communications originating from the ACS. The IP address and authentication information are extracted and stored (step 810) when the registration message is received at step 805. As mentioned above, the authentication information may include a CPE-generated CR URL. Of course, the ACS may respond to the registration message initiated by the CPE. For example, the ACS may provide CR credentials generated by the ACS (not shown) to the CPE. Note that although a single CPE registration is here contemplated for simplicity, there are typically a large number of CPEs that register with the ACS. This process is applicable to each of them.

If the ACS wishes to later initiate communication with the CPE, it may not be able to do so as a CGN associated private IP address is not addressable over a public network and any public address used in previous communications with the CPE device may now have been reassigned. To surmount this problem, in accordance with this embodiment of the present invention the ACS begins by generating a connection request (step 815), for example an HTTP GET message formed according to TR-69. The connection request contains proxy information. The proxy information in this embodiment includes the IP address and the authentication information stored by (or accessible to) the ACS, or information derived from it, which will enable the communication toward the target CPE to be successfully completed. The connection request is then transmitted to the primary blast box (step 820). Note that in most embodiments a single primary blast box is used, although in some implementations there may be more than one, interconnected and working in cooperation with each other.

In the embodiment of FIG. 8, the primary blast box then forwards the connection request (step 830) to each of the secondary blast boxes listed in its blast box registry. In addition, the proxy information is removed (step 835) and the connection request is forwarded to the IP address contained in the proxy information (step 840). In this manner the present invention provides for connection to CPE devices that are not associated with a CGN private network. Note, however, that in an alternate embodiment (not shown), the message of step 840 may be sent first by the blast box or by the ACS to determine if the CPE is reachable in this fashion. In this manner a CPE is reachable regardless of whether is behind a CGN or not (respectively, for example, CPEs 110a and 120a shown in FIG. 4).

In the embodiment of FIG. 8, the connection request forwarded at step 830 is then received and examined in each of the secondary blast boxes to which it has been sent (step 845), and the secondary blast box determines (step 850) whether the IP address in the proxy information corresponds with a private IP address assigned in the private network of the CGN with which the particular secondary blast. If not, the message is simply discarded (step 855). If, however, the IP address in the proxy information matches a private IP address in the CGN private network, the proxy information is removed (step 860) from the connection request and it is forwarded (step 865) to at least the CPE corresponding with the IP address.

Note that since may be several secondary blast boxes, each associated with a particular CGN private network, more than one CPE device (or many devices) may receive the connection request. In this embodiment, when a CPE device receives a connection request, an authentication protocol is executed (step 870), using the authentication information that was sent to the primary blast box and any secondary blast boxes. As mentioned above, this authentication information may include CR credentials or a CR URL, or both, that is, some combination of the two. If the connection request cannot be properly authenticated by the CPE, it is discarded (step 875). Assuming the proper CPE device is still active and available, however, it will at some point receive the connection request and proper authentication will occur, and the CPE device responds (step 880) by initiating a communication session with the originating ACS. In the usual implementation, a public IP address will be assigned to the CPE for this purpose and be used for the communication session (not shown in FIG. 8).

In some cases, of course, the target CPE may not be available or operational, perhaps due to an outage or connection failure. In this case no session initiation will be detected by the ACS. In this embodiment, the ACS determines whether a proper message (step 885) from the targeted CPE has arrived before the timer initiated at step 825 has expired. If the CPE has responded, the process simply continues with the management operations originally contemplated by the ACS. If no message has been received during the predetermined time period, however, the process returns to step 815 to generate another connection request. In a preferred embodiment (not shown), the timing of additional connection requests may be made according to rules establishing the number and frequency of such requests, which may depend on the identity of the CPE as well as other factors such as the urgency of the request or network traffic conditions.

In an alternate embodiment (not shown), the secondary blast box returns a connection request status message to the primary blast box, indicating whether the attempt to reach the target CPE was successful. This may be in the form of, for example, an HTTP response message. In most cases the primary blast box will receive a number of these response messages, which it can aggregate to provide a timely status report to the ACS or to some other entity. In this embodiment, the timer associated with the decision to send additional connection requests may look for a status report from the primary blast box as one factor or (the sole factor) in making this determination. It is preferred in this case that the connection requests to all secondary blast boxes be done at the same or nearly the same time to avoid undesirably long response aggregation periods.

Note that the sequence of operation illustrated in FIGS. 7 and 8 represent an exemplary embodiment; some variation is possible within the various embodiments of the invention. For example, additional operations may be added to those shown in the figures, and in some implementations one or more of the illustrated operations may be omitted. In addition, the operations of the methods may be performed in any logically-consistent order unless a definite sequence is recited in a particular embodiment.

FIG. 9 is a simplified schematic diagram illustrating selected components of a communications network 300 according to an embodiment of the present invention. Network 300 is similar in some ways to network 200 of FIG. 4, and analogous components are similarly numbered. No implication is made, however, that omitted elements are identical. The ACS 335 may simply be part of a core network, for example, or communicate directly with an access network.

In the embodiment of FIG. 9, ACS 335 communicates with a primary blast box 355 when it is necessary to initiate contact with a CPE of network 300, in a manner similar to that described above. Including the proxy information, primary blast box 355 then forwards the connection request received from ACS 335 to secondary blast boxes 360 and 365. It may also remove the proxy information and forward the connections request to the IP address in the proxy information, in case the target CPE is not associated with a secondary blast box or is otherwise publicly accessible. Secondary blast box 360 then removes the proxy information and transmits the connection request to the appropriate one of CPR devices 310a through 310n, with which it is associated (or in some cases, to a number of them). The presumption is made in this embodiment that secondary blast box 360 has no other blast boxes listed in a blast box registry, or that any listed are flagged as inactive. It is also presumed, of course, that the CPEs 310a through 310n are listed in its CPE registry.

In this embodiment, a similar process is carried out in secondary blast box 365, which by presumption has CPE's 315a through 315n listed in its CPE registry. It also has listed in a blast box registry the identity and address of tertiary blast box 370, which if applicable is flagged as active. The connection request is then also forwarded with proxy information included to tertiary blast box 370. As should be apparent, in this embodiment, tertiary blast box 370 is a device that is the same or similar to secondary blast boxes 360 and 365, except that it receives at least some connections requests not from primary blast box 355 but from secondary blast box 365. In other words, the “tertiary” designation refers only to its relative configuration within network 300.

Note that depending on the network topology, it is possible to have many levels of hierarchy in the connection-request distribution pipeline. While in many implementations there will be no more than 2, deeper hierarchies are conceivable in large geographically-distributed communications providers.

In the embodiment of FIG. 9, when tertiary blast box 370 receives the connection request, it removes the proxy information and forwards the connection request to one or more of the CPE devices 317a through 317n with which it is associated. Of course, if it also had one or more blast boxes listed in its blast box registry, it would forward the connection request with proxy information to them as well.

In this manner, the present invention provides a way for an ACS to remotely manage CPEs in a communication network even where a number of CGNs have been implemented that establish respective private networks encompassing some or all of the CPE devices.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of initiating communications with a CPE device associated with a communications network, the method comprising:
receiving in a primary blast box a connection request directed to the CPE, the connection request comprising proxy information, wherein the proxy information comprises an IP address associated with the CPE;
forwarding the connection request to at least one secondary blast box, wherein the at least one secondary blast box is associated with a private network of the communication network.

2. The method of claim 1, further comprising extracting the proxy information from the connection request and forwarding the connection request without the proxy information to the IP address associated with the CPE.

3. The method of claim 2, wherein the connection request without the proxy information is forwarded by the primary blast box.

4. The method of claim 2, wherein the connection request without the proxy information is forwarded by the at least one secondary blast box.

5. The method of claim 1, wherein the proxy information further comprises CR credentials previously generated and transmitted to the CPE.

6. The method of claim 1, wherein the proxy information further comprises a CR URL previously generated by the CPE.

7. The method of claim 1, further comprising generating the connection request in an ACS and transmitting the connection request to the primary blast box.

8. The method of claim 7, further comprising initiating a timer when the connection request is transmitted and generating a second request if a communication from the CPE has not been received prior to expiration of the timer.

9. The method of claim 1, further comprising forwarding the connection request to a tertiary blast box from the at least one secondary blast box.

10. The method of claim 1, wherein the at least one secondary blast box comprises a plurality of secondary blast boxes, wherein each secondary blast box of the plurality of secondary blast boxes is associated with a respective CGN.

11. The method of claim 1, further comprising receiving a connection-request status message from the at least one secondary blast box indicating whether authentication with the CPE was successful.

12. The method of claim 11, wherein the at least one secondary blast box comprises a plurality of blast boxes, and further comprising aggregating received connection-request status messages and transmitting a connection-request response message to the entity originating the connection request.

13. A network element for facilitating communications with a CPE, comprising:
a processor;
a memory device in communication with the processor, the memory device comprising a secondary element registry;
a message handler controlled by the processor configured to receive connection request messages and to forward the connection request messages received in the network element to secondary network elements listed in the secondary element registry.

14. The network element of claim 13, wherein the network element is incorporated into an ACS that generates the connection request messages.

15. The network element of claim 13, wherein the message handler is further configured to determine an IP address associated with a connection request and to forward the connection request to the IP address.

16. The network element of claim 13, wherein the secondary element registry comprises a flag for each entry to indicate whether it is active or inactive, and wherein the message handler only forwards received connection requests to secondary network elements flagged as active.

17. The network element of claim 13, wherein the secondary element registry is dynamically updatable to reflect the addition or removal of private networks.

18. The network element of claim 13, wherein the received connection request messages comprise proxy information and wherein the message handler is further configured to remove the proxy information prior to forwarding.

19. A system for managing CPE devices, comprising:
a primary blast box comprising a blast box registry; and
at least one secondary blast box comprising a CPE registry,
wherein the primary blast box is configured to receive a connection request from to forward the connection request to the at least one secondary blast box.

20. The system of claim 19, wherein the primary blast box comprises an ACS interface for receiving connection requests generated by the ACS.
